(19) United States
(12) Patent Application Publication
(10) Pub. No.: US 2021/0006704 A1
(43) Pub. Date: Jan. 7, 2021

(54) Dimension Measurement Device

(71) Applicant: YUYAMA MFG. CO., LTD., Osaka (JP)

(72) Inventors: Yoshinori SHIRAHARA, Osaka (JP); Hajime MISHIMA, Osaka (JP); Yuya TOMIOKA, Osaka (JP); Masashi NISHIO, Osaka (JP)

(73) Assignee: YUYAMA MFG. CO., LTD., Osaka (JP)

(21) Appl. No.: 16/766,494

(22) PCT Filed: Nov. 16, 2018
(86) PCT No.: PCT/JP2018/042471

§ 371 Date: Sep. 18, 2020

(30) Foreign Application Priority Data
Nov. 27, 2017 (JP) 2017-226835

(51) Int. Cl. H04N 5/235; G01B 11/02; G06T 7/62; G06T 7/00; G06T 3/60; A61J 1/03

(52) U.S. Cl. CPC H04N 5/2354; G01B 11/02; G06T 7/62; G06T 7/0012; G06T 2207/30004; G06T 3/608; A61J 1/03; G06T 2207/10152; H04N 5/2351

(57) ABSTRACT

[Problem] To provide a dimension measurement device without influenced by change in a usage environment while being able to measure precisely a dimension of medicine.

[Solution] A dimension measurement apparatus S1 comprising a light source part L, a photographing part C, a medicine holder part H holding a medicine 1 disposed between the photographing part C and the light source part L while holding the medicine 1 being able to be photographed from different directions, a light source output power adjustment part U1 performing brightness adjustment of the light source part L based on luminosity of photographed image photographed by the photographing part C, and a shape measuring part U2, measuring an X direction and a Y direction of medicine 1 in an X direction and a Y direction each crossing at right angles with respect to the photographed image photographed after the brightness adjustment has performed at least one time.

### FIELD OF INVENTION

The present invention relates to a dimension measurement device for measuring a dimension of medicine from a photographed image of tablet-type medicine.

### BACKGROUND ART

Conventionally, as one that describes an art relating to such a dimension measurement device, for example, the following Patent Literature 1 is known.

The invention described in this Patent Literature 1 makes medicines having tablet shapes hold at a medicine holder part; sets postures of the medicine holder part at right angled two postures each other, and photographs the medicines in each posture. Based on photographed images such as obtained upper outline images or lateral outline images and the like, dimensions of medicines can be measured to specify a shape of medicine.

When photographing, light from a light source is illuminated to the medicine. However, the Literature describes only that a lighting part starts lighting when images are photographed by a camera and stops lighting after photographing is completed (paragraph [0188]).

Besides, with respect to a lighting method, it is described that, for example, at a second posture for photographing a lateral face of the medicine, two light sources are turned off and only other two light sources are turned on among four light sources in the lighting part. Thereby halation that may occur if all of the light sources is turned on is prevented (paragraph [0203]).

With respect to the photographed images, it is described that images are corrected if the medicine is photographed at an inclined posture. For example, a controller part detects displacement amounts along a height direction of both ends in a width direction of lateral outline images which are the lateral images of medicines. If inclination less than allowed amounts in the lateral outline image, the controller part corrects the dimensions of tablet along a width direction and a height direction and the like in the lateral outline image. For example, if an incline angle is assumed to be θ; a dimension along the width direction of the lateral outline image is assumed to be α; and an original dimension along the width direction is assumed to be β, the dimension β is calculated according to β=α/cos (θ) (paragraphs [0218], [0220]).

### PRIOR ART LITERATURE

### Patent Literature

Patent Literature 1: WO2015/119055A1 Pamphlet

### SUMMARY OF INVENTION

### Problem to be Solved by Invention

When dimensions of medicines are recognized from photographed images, intensity of illumination is important at positions on medicine surfaces in the photographed images. When the intensity of illumination is not adequate, the outline can not be obtained precisely because the outline of the medicine becomes opaque and so on such that errors will take place in the measured dimensions of medicines. On the other hand, brightness of light source changes depending on temperature change in an ambient environment or degradation of light source itself and the like.

However, a dimension measurement device of Patent Literature 1 does not describe the brightness change of light source and also does not disclose good and bad of finish of photographed images. Thus, dimensions obtained are not always precise ones.

Besides, when specifying an inclination angle of medicine image, for example, heights between both ends along the width direction of the medicine are compared in the lateral outline image and based on positions of both ends, the inclination of medicine is determined. This is based on the expectation that the lateral outline of the medicine is, in most cases, symmetrical in the vertical and horizontal two directions across a center position and based on that when photographed at an inclined state, the heights between both ends as characteristic points of medicine should change. However, depending on medicines, corner parts are not distinguished due to small curvatures of outlines. In such cases, the positions of both ends can not be determined precisely and there are cases that difference of heights between both ends is measured excessively. Such measurement error becomes more larger and larger when the lateral outline image is opaque.

Furthermore, the dimensions along the width direction such obtained are multiplied by a numeral value depending on an inclined angle to obtain a width of medicine. If the inclination does not occur in an upper outline image photographed at another posture, multiplying of such numeral value can be omitted to determine a dimension measurement value. That is to say, both dimension measurement values have different arithmetic processes such that the values of errors to be included therein will change so that in the strict sense, the reliability on dimensions becomes different.

As described above, in the above prior art, there is yet a requirement for the measurement of medicine dimension precisely based on photographed images. Thus, a dimension measurement device, which can measure the dimension of medicine precisely with omitting the effect of change in a usage environment, has been requested so far.

### MEANS FOR SOLVING PROBLEM

### Characteristic Configuration

The characteristic configuration of dimension measurement device of the present invention is to comprise:

a light source part;

a photographing part;

a medicine holder part holding a medicine disposed between the photographing part and the light source part while holding the medicine being able to be photographed from different directions;

a light source output power adjustment part performing brightness adjustment of the light source part based on brightness of a photographed image photographed with the photographing part; and

a dimension determination part measuring an X dimension and a Y dimension of the medicine in the X direction and the Y direction crossing at right angles each other in the photographed image photographed after performing at least one brightness adjustment.

### Advantageous Effect

If the dimension of medicine is measured, there are various outer shapes and kinds of color of medicines. Thus, there is the possibility that depending on strength of light coming out from the light source an outline of medicine becomes blur or the image of medicine itself becomes changed. Therefore, according to the present configuration, based on the photographed image, which is obtained by photographing the medicine at least one time with the photographing part, brightness adjustment of light source part is performed. Thereby, the image of medicine becomes clear and then, accuracy of dimension measurement subsequently performed will be increased.

### Characteristic Configuration

In the dimension measurement device of the present invention, it can be configured such that the light source part illuminates the medicine from a position opposite to the photographing part and the medicine holder part is configured from a transparent material, and the brightness adjustment of the light source part is performed based on luminosity of a region other than regions of the medicine, the light source part and the medicine holder part in the photographed image.

### Advantageous Effect

The brightness adjustment by the light source output power adjustment part is performed based on a measurement result for brightness change in the photographed image. In the present configuration, the medicine becomes shadow in the photographing image such that the brightness change in the medicine region is small. Besides, the light source part itself does not change luminosity about the center position even if the brightness is changed. Furthermore, the medicine holder part is configured from material having transparency, however, amounts of light transparency changes by changing stain degrees and so on.

Thus, there is not large corresponding relation between the brightness of medicine holder part and clearness of medicine image. From the above facts, the dimension measurement device of present configuration improves image quality of medicine image by the brightness adjustment based on the region other than the above three regions in the photographed image.

### Characteristic Configuration

In the dimension measurement device of the present invention, it is preferred to configure it such that the photographing part is disposed with an operation part for indicating start of photographing by an operator; and as a result of the brightness adjustment of the light source part by the light source output power adjustment part, operation of the operation part is configured to be possible at a condition where luminosity of the photographed image satisfies a predetermined condition.

### Advantageous Effect

The dimension measurement device of present configuration is, for example, disposed to a medicine dispensing apparatus. When charging the medicines into the dispensing apparatus, for performing adequate dispensing of medicines, the medicine is mounted to the dimension measurement apparatus and the dimension of medicine is made recognized to the dispensing apparatus. If an operation part for photographing the medicine image is disposed to the photographing part, an operator can operate the operation part in optional timing after charging the medicine to the dimension measurement device.

In the present configuration, the operation of the operation part becomes possible under the condition where the luminosity of the photographing image becomes adequate by the brightness adjustment of light output power adjustment part, and since an X direction and a Y direction is measured based on the photographed image obtained after this operation, the dimension measurement can not performed un der the condition where the brightness of the medicine image is insufficient. Thereby, the dimension measurement accuracy will be excellent.

### Characteristic Configuration

In the dimension measurement device of the present invention, it is preferred to configure it such that the photographing part is disposed with an operation part for indicating start of photographing by an operator; and operation of the operation part is configured to be possible at a condition where brightness adjustment working scheduled beforehand by the light source output power adjustment part is completed.

### Advantageous Effect

If the operation part is disposed, as the timing when the operation of the operation part by the operator is allowed, the timing after completion of brightness adjustment working of light source output power adjustment part as the present configuration may be provided. In this case, contents of brightness adjustment working may be variously set such that number of times for brightness adjustment is set beforehand and so on. By setting the number of times for the brightness adjustment, the brightness of LED can be set to an approximately adequate value. According to the present configuration, after the operator mounts the medicine to the dimension measurement device and when approximately certain time has passed, the brightness adjustment of light output power adjustment part will be completed so that the operation part of photographing part may be possible.

### Characteristic Configuration

The dimension measurement device of the present invention may be configured such that the brightness adjustment of the light source output power part by the light source output power adjustment part is configured to be performed repeatedly until the operator instructs start of photographing.

### Advantageous Effect

If the photographing part comprises the operation part, the timing when the operator operates the operation part is optional. it is assumed that the operation part is not operated after completion of the brightness adjustment by the light source output power adjustment part, for example, there is the possibility that the brightness of the light source part will change due to heating of light source part. Thus, according to the present configuration, the brightness adjustment will be repeatedly performed until the medicine image is actually photographed even though the brightness adjustment is completed once such that the photographing image in the optimum brightness is obtained.

### Characteristic Configuration

In the dimension measurement device of the present invention, it is preferred to configure it such that the photographing part is configured to take photograph automatically if luminosity of the photographed image satisfies a condition set beforehand as a result of brightness adjustment of the light source by the light source output power adjustment part.

### Advantageous Effect

The present configuration omits a manual operation of photographing part by the operator and makes the photographing part perform automatically the photographing operation. In such case, the luminosity of photographed image becomes a predetermined condition and immediately photographing is performed so that the photographing image can be obtained in the shortest time duration from mounting of medicine.

### Characteristic Configuration

In the dimension measurement device of the present invention, the photographing part may be configured to perform photographing automatically after completion of the brightness adjustment of the light source scheduled beforehand by the light source output power adjustment part.

### Advantageous Effect

The present configuration is one that defines contents of brightness adjustment of light sour part when photographing is made automatically to perform. In this case, although the brightness is not always set to the optimum, by performing a predetermined brightness adjustment, it is estimated that the brightness of light source part is set to an approximately adequate value. Thereby, the time duration between start of brightness adjustment by the light source output power adjustment part and the completion of dimension measurement for the medicine by the photographing part can be constant so that the brightness can be set within a determined time duration.

### Characteristic Configuration

In the dimension measurement device of the present invention, the medicine holder part may comprise a placement part for placing the medicine and a pair of arm parts sandwiching the medicine by changing spacing each other along the placement face upon holding the medicine.

### Advantageous Effect

By configuring the medicine holder part as the present configuration, holding of medicine becomes extremely easy. That is, by disposing the placement face which can place the medicine, a holding posture of medicine is approximately determined. Furthermore, by disposing a pair of the arm part movable along the placement face, the posture of medicine on the placement face can be certainly held. Thereby, according to the present configuration, the dimension measurement device, which is easy to hold the medicine and is possible to perform the dimension measurement, can be obtained.

### Characteristic Configuration

The dimension measurement device of the present invention can be configured such that the medicine holder part comprises a rotation axis shaft along a direction for changing the spacing between a pair of the arm parts and is able to change the placement face between a first posture and a second posture being right angled each other about the rotation axis shaft;

wherein

if the first posture is set to a posture where a light axis of the photographing part and the placement face cross at right angles;

the photographing part photographs;

a first photographed image if the medicine holder part is at the first posture; and

a second photographed image if the medicine holder part is at the second posture; and

wherein

the dimension determination part sets to at least one of the first photographed image and the second photographed image a rectangular frame that encloses an outline of a medicine image showing the medicine as a condition with contacting four sides while making a difference between a long side and a narrow side maximum, calculates a minimum rotation angle for making the rectangular frame rotate so as to align with a direction along the rotation axis shaft or a direction perpendicular to the rotation axis shaft, performs skew correction by making rotate the medicine image for the rotation angle, and calculates the X dimension using a direction along the rotation axis shaft as the X direction for the medicine image performed with the skew correction.

### Advantageous Effect

Since the placement of medicine to the medicine holder part is performed by the operator, there may be the case that the medicine is not held to the medicine holder part in an adequate posture. For example, if a part of medicine is placed on the placement face in the condition where the part is raised toward the light axis, there may be the case that the X dimension becomes short in the measurement based on the photographed image.

Furthermore, in the case where a medicine shape has an ellipse shape rather than a perfect circle, when the medicine is held with a pair of the arm part, there may be the case that the medicine is fixed inclinedly. In such case, the measured X dimension becomes long.

Thus, according to the present configuration, in order to correct these measurement errors, the medicine image in the photographed image is subjected to skew correction. As such configured, a long side direction and a narrow side direction of medicine image are re-arranged into the direction along the rotation axis shaft and the direction perpendicular thereto in the photographed image so that the measurement accuracy in the X direction can be enhanced.

According to the present configuration, necessity for changing a measurement program for the X direction depending on the inclination will be omitted. Besides, if the dimension of medicine is intended to obtain from calculation, since the outer shape of medicine has a predetermined convex shape, errors occur in extraction of a longer diameter position and a shorter diameter position and hence the error are accumulated in the dimension calculation. However, if a normal X dimension is measured after the skew correction, such errors do not occur.

### Characteristic Configuration

In the dimension measurement device according to the present invention, if the rotation angle in the first photographed image is not less than a threshold value set beforehand, the X dimension after the skew correction to the first image may be set as the final X dimension of the medicine.

### Advantageous Effect

If the medicine image inclines largely in a first photographing image, the X dimension and the Y dimension of medicine have less difference in most cases. In this case, the thickness of medicine is mostly short when compared to the X dimension ad the Y dimension, and a placement condition becomes stable when the medicine is placed on the placement face such that there is hardly the case where the part is raised against the placement face. Therefore, in this case, by performing the skew correction to the medicine image in the first photographed image, the X dimension of medicine can be obtained almost precisely.

### Characteristic Configuration

In the dimension measurement device according to the present invention, if the rotation angle in the first photographed image is less than a threshold value set beforehand, the X dimension after the skew correction to the second image may be set as the final X dimension of the medicine.

### Advantageous Effect

If the medicine image in the first photographed image has small inclination or has no inclination, the placement posture of medicine to the medicine holder part is mostly stable, and in other words, the Y dimension of medicine is mostly longer than the X direction, for example, the medicine has a stick shape. In this case, there is the case where a part of medicine is raised under a second posture such that the inclination of medicine image becomes large in the second photographed image. Thus, a rotation angle for the inclination correction becomes large in the second photographed image.

Thus, if the rotation angle in the first photographed image is smaller than a threshold set beforehand, by performing the skew correction to the medicine image in the second photographed image, the X dimension of medicine can be obtained almost precisely.

### Characteristic Configuration

In the dimension measurement device according to the present invention, the X dimension after the skew correction for the first photographed image and the X dimension after the skew correction for the second photographed image are compared and the X dimension of larger one may be set as the final X dimension of the medicine.

### Advantageous Effect

There are various medicine shapes and there is the possibility that the posture of medicine placed on the medicine holder part becomes much variable. The dimension measurement device of present configuration is disposed accompanied with the dispensing apparatus of medicine and the X dimension measured about the medicine is used to space-setting of mesh part and so on. Thus, for determining arrangement positions for various members so as to allow certain passage of medicines, there is necessity to specify the maximum width of medicine. The present configuration performs thereby the skew correction to the first photographing image and the second photographing image, and by adopting the X dimension of larger one, smooth transferring working of medicine is realized.

### Characteristic Configuration

The characteristic configuration of dimension measurement method according to the present invention is to comprise:

a light source part;

a photographing part;

a medicine holder part holding a medicine disposed between the photographing part and the light source part while holding the medicine being able to be photographed from different directions;

a dimension determination part measuring an X dimension and a Y dimension of the medicine in the X direction and the Y direction crossing at right angles each other in the photographed image photographed after performing at least one brightness adjustment, and when performing dimension measurement of the medicine the method performing;

setting a posture of the medicine to an light axis of the photographing part to at least either a first posture or a second posture crossing at right angles each other, after setting the light source part to predetermined brightness, obtaining the photographed image with the photographing part, after preparatory photographing at least one time for measuring luminosity of the photographed image, and performing sample photographing.

### Advantageous Effect

If the dimension of medicine is measured, there are various outer shapes and kinds of color of medicines. Thus, there is the possibility that depending on strength of light coming out from the light source an outline of medicine becomes blur or the image of medicine itself becomes changed. Therefore, according to the present configuration, based on the photographed image, which is obtained by photographing the medicine at least one time with the photographing part, brightness adjustment of light source part is performed. Thereby, the image of medicine becomes clear and then, accuracy of dimension measurement subsequently performed will be increased.

### Characteristic Configuration

The dimension measurement method according to the present invention may be one that the medicine holder part comprises:

a placement part for placing the medicine;

a pair of arm parts sandwiching the medicine by changing spacing each other along the placement face upon holding the medicine; and

a rotation axis shaft along a direction for changing the spacing between a pair of the arm parts and crossing the light axis at right angles;

wherein

if the first posture is assumed to be a posture where the placement face crosses the light axis at right angles;

making the placement face rotate about the rotation axis shaft to achieve the first posture or the second posture;

after the sample photographing, enclosing an outline of the medicine image showing the medicine in the photographed image with a rectangular frame as a condition with contacting four sides while making a difference between a long side and a narrow side maximum,

calculating a minimum rotation angle for making the rectangular frame rotate so as to align with a direction along the rotation axis shaft or a direction perpendicular to the rotation axis shaft to perform skew correction by making rotate the medicine image for the rotation angle, and

calculating the X dimension using a direction along the rotation axis shaft as the X direction for the medicine image performed with the skew correction.

### Advantageous Effect

Since the placement of medicine on the medicine holder part, there is the case that the medicine is not held in an adequate posture to the medicine holder part. For example, a part of medicine is placed on the placement face in the condition where the part is raised toward the light axis direction of photographing part, there may be the case where the X dimension becomes short in the measurement based on the photographed image.

Furthermore, in the case where a medicine shape has an ellipse shape rather than a perfect circle, when the medicine is held with a pair of the arm part, there may be the case that the medicine is fixed inclinedly. In such case, the measured X dimension becomes long.

Thus, according to the present configuration, in order to correct these measurement errors, the medicine image in the photographed image is subjected to skew correction. As such configured, a long side direction and a narrow side direction of medicine image are re-arranged into the direction along the rotation axis shaft and the direction perpendicular thereto in the photographed image so that the measurement accuracy in the X direction can be enhanced.

According to the present configuration, necessity for changing a measurement program for the X direction depending on the inclination will be omitted. Besides, if the dimension of medicine is intended to obtain from calculation, since the outer shape of medicine has a predetermined convex shape, errors occur in extraction of a longer diameter position and a shorter diameter position and hence the error are accumulated in the dimension calculation. However, if a normal X dimension is measured after the skew correction, such errors do not occur.

### BRIEF DESCRIPTION OF DRAWINGS

FIG. 1 An explanatory drawing illustrating an appearance of medicine dispensing apparatus according to an embodiment.

FIG. 2 An explanatory drawing illustrating an essential structure of dimension measurement apparatus according to an embodiment.

FIG. 3 An explanatory drawing illustrating posture changes of medicine holder part according to an embodiment.

FIG. 4 An explanatory drawing illustrating one example of first photographed image and second photographed image.

FIG. 5 A flowchart illustrating procedures for brightness adjustment of photographed image.

FIG. 6 An explanatory drawing illustrating one stage of image processing for photographed image.

FIG. 7 An explanatory drawing illustrating one stage of image processing for photographed image.

FIG. 8 An explanatory drawing illustrating one stage of dimension measurement of medicine based on a first photographed image.

FIG. 9 An explanatory drawing illustrating procedures of dimension measurement.

FIG. 10 An explanatory drawing illustrating one stage of dimension measurement of medicine based on a second photographed image.

### MODE FOR PRACTICING INVENTION

### Embodiments

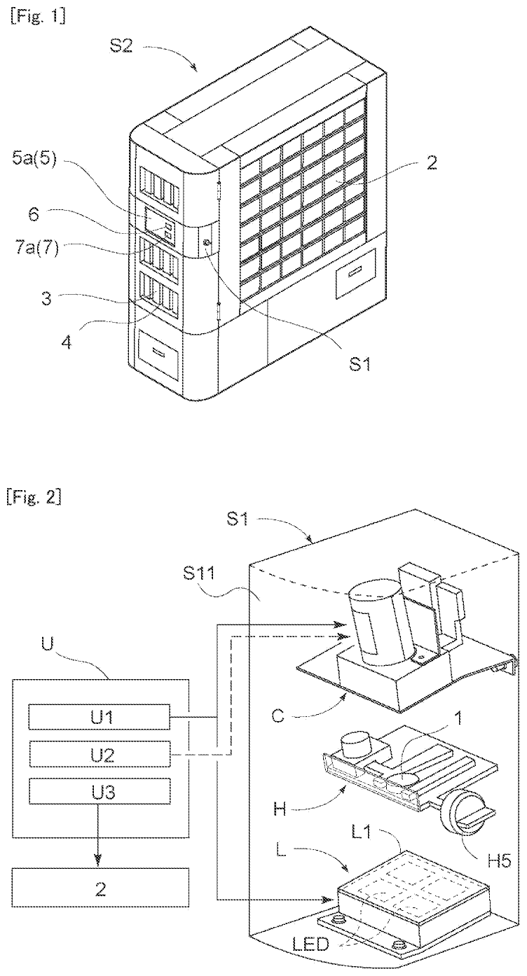

With referring to FIG. 1-FIG. 10, an embodiment of dimension measurement device S1 of the present invention will be described. The dimension measurement device S1 is used, for example, with incorporated to a medicine dispensing apparatus S2 for dispensing various tablets of predetermined number as a medicine 1 to a medicine container and the like, and measures at least one of three dimensions of medicine 1.

As shown in FIG. 1, the medicine dispensing apparatus S2 comprises a plurality of cassettes 2 to which tablets are reserved for every kind. For example, when a kind and the number of tablets to be dispensed are instructed by a personal computer recording precipitations, one of a medicine containers 3 stocked at a particular position of the medicine dispensing apparatus S2 is moved in front of the cassette 2 which reserves tablets to be dispensed, and is carried to a dispensing port 4 after dispensation of predetermined tablets.

The cassette 2 reserving the tablets can reserve tablets in various dimensions. The cassette 2 comprises the passage through which the tablets dispensed pass through and the passage is disposed with a width regulator part for changing a width of the passage depending on dimensions of reserved tablets and a height regulator part for changing a height (not shown). Thereby, the tablets with the precise number can be dispensed by allowing the tablets to pass one by one. Now, depending on the cassette 2, there are one that the width regulator part and the height regulator part are fixed and also there I one that positions of the width regulator part and the height regulator part can be changed so as to reserve tablets with various dimensions.

The dimension measurement device S1 of the present invention is used for measuring the dimensions of medicine 1 when the cassette 2 filled with the medicine 1 as a tablet is mounted into the medicine dispensing apparatus S2. For example, one medicine 1 is taken out from the cassette 2 to be installed and the medicine 1 is photographed after mounted to the dimension measurement device S1. Based on the photographed image F, a width dimension Dx, vertical dimension Dy, and height dimension Dz are measured. Based on this measurement, the width regulator part and the height regulator part of the cassette 2 mounted to the medicine dispensing apparatus S2 are manually or automatically adjusted.

### Device Configuration

As shown in FIG. 2, the dimension measurement device S1 of the present invention comprises a medicine holder part H for holding the medicine 1 having a tablet shape, a photographing part C for photographing the medicine 1 from a plurality of directions, and a light source part L for illuminating the light to the medicine 1 from the side opposite to the photographing part C beyond the medicine 1.

### Lighting Source Part

The lighting source part L may be configured by arranging a plurality of LEDs in a plane shape. Each of LEDs is able to adjust its brightness by a light source output power adjustment part U1 disposed at the controller part U. The brightness adjustment is performed, as described later, by changing voltage applied to the LEDs with the light source output power adjustment part U1. Now, between the LEDs and the medicine holder part H, a scatter plate L1 is disposed to disperse the light emitted from the LEDs over the hole region of photographing region.

As the LEDs, various kind of color may be used. However, since the present embodiment takes mainly the photograph of medicine 1 and most of medicine 1 has white color and so on, LEDs with red color is preferred. When the LEDs have red color, the outline of the white medicine 1 becomes easy to be represented. Thereby, accuracy of dimension measurement of the medicine 1 can be improved.

### Medicine Holder Part

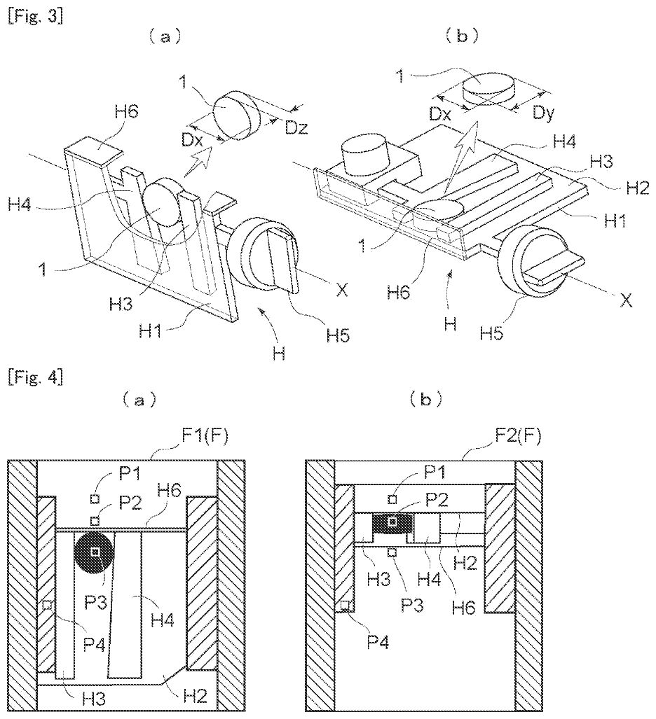

The medicine holder part H comprises a holder part body H1 having a placement face H2 for placing the medicine 1, a pair of arm parts for holding by sandwiching the medicine 1 by changing spacing therebetween along the placement face H2 when holding the medicine 1. One is a fixed arm part H3 positionally fixed to the placement face H2, and the other is a movable arm part H4 becoming near and apart to the fixed arm part H3. For example, when the medicine 1 has a disc shape, after laying the medicine 1 on the placement face H2, the position of movable arm part H4 is adjusted to sandwich the medicine 1. This adjustment may be, as shown in FIG. 3(b), motor driven one, or may be manual one that manually changes a position of pressing spring to open and close the movable arm part H4 (not shown).

The holder part body H1 is disposed while its basic posture inclined and is disposed with a wall plate H6 at a bottom edge part along the inclination. The reason of inclined disposition is to make the placement position of medicine 1 stable. The wall plate H6 is one that makes the placed medicine 1 contact and is configured by a resin material with transparency.

The holder part body H1 sandwiching the medicine 1 is able to rotate at least over 90 degrees about a rotation shaft X. At end of the rotation shaft X, a handle H5 is disposed operable by an operator. Thereby, the placement face H2 can be changed from a vertical posture shown in FIG. 3 (a) to a horizontal posture shown in FIG. 3 (b). While not illustrating, to the handle H5 or the rotation shaft X a convex part and so on is disposed, the convex part abutting with bias force to a housing S11 of the dimension measurement device Si to fix the posture of the holder part body H1 to a horizontal posture or a vertical posture.

As described above, by making it possible to set the placement face H2 at the horizontal posture, positioning of medicine 1 becomes easy when holding the medicine 1 with a pair of the arm parts while making it possible to set the posture of the medicine 1 in the stable posture. Thereafter, the medicine 1 is held on the placement face H2 in the near ideal posture by the fixed arm part H3 and the movable arm part H4. According to this configuration, holding of the medicine 1 becomes easy and accuracy in the dimension measurement of the medicine 1 may be improved.

The medicine holder part H may be configured by various transparent resin materials so as to pass the light from the light source part L. Thereby, the photographing part C can photograph a silhouette of the medicine 1 whichever the posture of the holder part body H1 becomes changed.

### Brightness Adjustment

Hereafter, an example will be shown when the brightness adjustment is performed based on a first photographed image F1 obtained at a first posture. To obtain the photographed image F adequately for dimension measurement, the controller part U is disposed to the light source output power adjustment part U1 for adjusting the brightness of light source part L based on luminosity of the photographed image F photographed by the photographing part C. For measuring the dimensions along three directions of medicine 1, the outline of medicine image Fa to be an object of the dimension measurement is necessarily clear. Thus, the light source output power adjustment part U1 performs test photographing before obtaining the medicine image Fa and, based on an obtained photographed image F, performs brightness adjustment of the light source part L such that a photographing condition of the medicine 1 becomes optimum.

### Example for Brightness Adjustment

In FIGS. 4 (a), (b), one example of photographed images F obtained from the test photographing used when the brightness adjustment is performed. These photographed images Fs are ones for explaining working processes of brightness adjustment and when usual charging work of medicine 1 is practiced, such photographed images F are not displayed on a display part 5 of medicine dispensing apparatus S2.

FIG. 4(a) shows a first photographed image F1 photographed under the condition corresponding to the first posture that the placement face H2, on which the medicine 1 is placed, crosses a light axis of photographing part C at right angles. For obtaining the first photographed image F1 in which the outline of the medicine 1 appears adequately, for example, the brightness adjustment will be made efficient if the brightness can be evaluated by focusing a particular region in the first photographed image F1. Thus, as shown in FIG. 4 (a), points P1-P4 were set as candidates of brightness measurement points.

After that, a plurality of first photographed images F1 were obtained by changing variously the brightness of light source part L. In these first photographed images F1, the light source output power adjustment part U1 measures the brightness of points P1-P4, and amounts of change in the brightness in each of points were examined. Particularly, when the brightness, with which the first photographed image F1 providing the good image of medicine 1, is assumed as the center, the point having a large variation width in the brightness measurement value at anteroposterior conditions was selected. Such point makes it easy to select the optimum image from the first photographed images F1 continuously taken. As described above, the point P2 in FIG. 4 (a) was adopted as the brightness measurement point.

The position of point P2 is the position on the scatter plate L1 being apart from the center of LEDs, and is the position different from the position of medicine holder part H or the medicine 1. Upon practical measuring of medicine dimension, the brightness adjustment is repeated for predetermined number of times so as to make the brightness value of this position become within a set brightness value range beforehand. As the result, after setting to the required brightness, an acknowledgement for completion of brightness adjustment at the first posture is displayed on the display part 5 of medicine dispensing apparatus S2, or alternatively true measurements of medicine 1 at the first posture is automatically started.

As in the present embodiment, photographing is performed with the remarkable brightness at the center position of LED even when the scatter plate L1 is positioned between the light source L and the medicine holder part H. Besides, between the center position of LED and the peripheral position, the variation of brightness with respect to the variation of supply current to the LED is not same. Therefore, by performing the brightness adjustment based on the brightness at the position different from the center position of LED, more adequate brightness adjustment can be made. On the other hand, in the region of peripheral region of first photographed image F1 while having darker luminosity compared to regions of center position of LED as well as the peripheral region, the dark condition is kept because the variation of brightness of LED provides less impact. Therefore, in this peripheral region, the brightness measurement point Pn is not set.

As described above, the brightness measurement point Pn is determined to a spot region near to the medicine 1 at the position different from the center position of LED. By keeping the brightness at this point at a constant, inconvenience of blurring or wearing of outline for the medicine 1 can be avoided. Using the present configuration, by reading only the brightness of brightness measurement points Pn, the computation and so on for averaging the brightness of regions having a certain area in the first photographing image F1 can be omitted so that the brightness of light source part L can be quickly set.

Now, further conditions may be determined as the brightness measurement points Pn. For example, in addition to the position different from the center position of LED, preferred results may be obtained based on the brightness of region except for the region of medicine 1 and the medicine holder part H. Since the light source part L is positioned at the back of medicine 1 when viewed from the photographing part C, the image of medicine 1 becomes always a shadow image. Therefore, the position of medicine 1 has less brightness and also has less brightness variation. Besides, although the medicine holder part H is configured with the material having transparency, light transmittance amounts change depending on stain degrees. Thus, the brightness of medicine holder part H is not completed one as the condition for obtaining the clear medicine image Fa. Therefore, by performing the brightness adjustment based on the brightness of region other than the above three regions within the first photographed image F1, the image quality of medicine image Fa will be improved.

The dimension measurement accompanied with such brightness adjustment is performed every time when new medicines 1 are charged to the cassette 2 and the cassette 2 is mounted to the medicine dispensing apparatus S2. Furthermore, in each of the dimension measurement, the brightness adjustment is performed every time when photographing is performed. This is due to addressing to changes at every moment in the photographing environment such as the change in the brightness of LEDs depending on an ambient temperature and so on. Besides, there is also the purpose to prevent dimension measurement errors due to differences in color of individual medicine 1, which the condition of outline for the medicine image Fa becomes changed. For example, if the medicine 1 has either near white color or near black color as well as presence or absence of gloss, the image condition of medicine 1 in the photographed image F becomes different. Therefore, the brightness adjustment is required for every medicine 1 so as to remove blurring or wearing of outline of medicine 1. Thereby, precise dimension measurements of medicine 1 become possible.

FIG. 4 (b) shows a second photographed image F2 when the medicine 1 is photographed at the second posture that the placement face H2 of medicine 1 is set parallel to the light axis of photographing part C. In this second photographed image F2, the same brightness measurement points P1-P4 with ones in the first posture are set and the light output power adjustment part U1 measures each brightness. In the second photographed image F2, as the brightness measurement point Pn for evaluating the brightness is set to, for example, the P1 point. However, this position is different from the center of LEDs nor the position of medicine 1 and is the position overlapping to the medicine holder part H. According to the former description, the position of the medicine holder part H is not optimized one because the transparency of the medicine holder part H varies. However, this position has an advantage in the point that this position is near to the medicine 1. Thus, in order to reduce the effect of transparency of medicine holder part H, a thickness of wall plate H6 of medicine holder part H is configured as thin as possible.

When the brightness adjustment in the second posture, has been completed, an acknowledgement, which the brightness adjustment in the second posture is completed, is displayed on the display part 5 of medicine dispensing apparatus S2 and operations of an operator relating to sample photographing is promoted, or the sample photographing is started automatically in the second posture.

The test photographing relating to the brightness adjustment is performed at least one time in each of first posture and second posture when the dimension measurement of every medicine 1 is performed. More number of times for test photographing enhances the possibility for obtaining the optimized value. However, when considering efficiency of working, the number of times for photographing about one medicine 1 may be determined.

Furthermore, when the brightness of LEDs is made to change stepwise, the brightness value to be changed at one time may be determined. The brightness of LEDs changes, for example, depending on the environment temperature and if the same voltage is applied, the brightness becomes less and less when the ambient temperature becomes lower and lower. Therefore, by knowing the range of approximate environment temperature in the usage with respect to the LEDs to be used while knowing the change amounts of brightness of LEDs depending on the temperature, the brightness of LEDs to be changed at one time can be set adequately.

### Operation of Brightness Adjustment

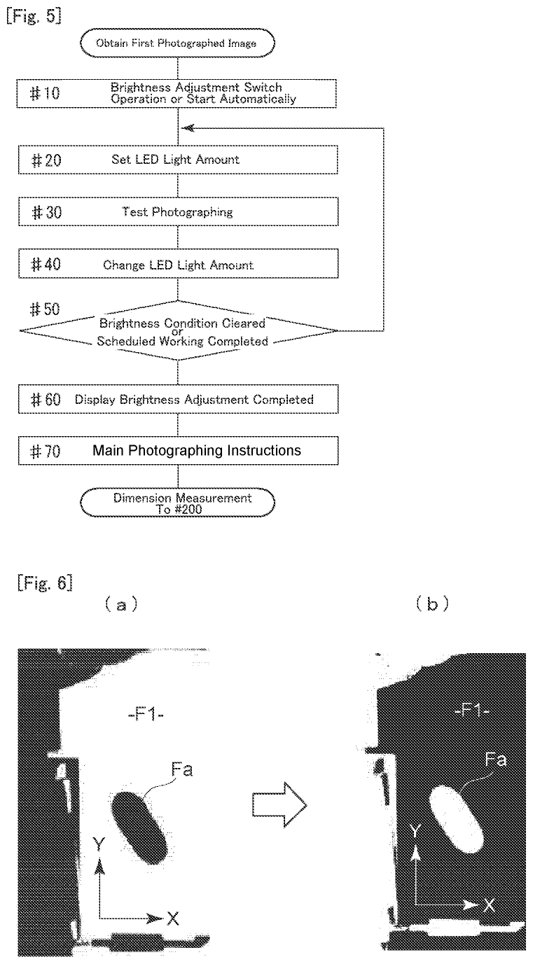

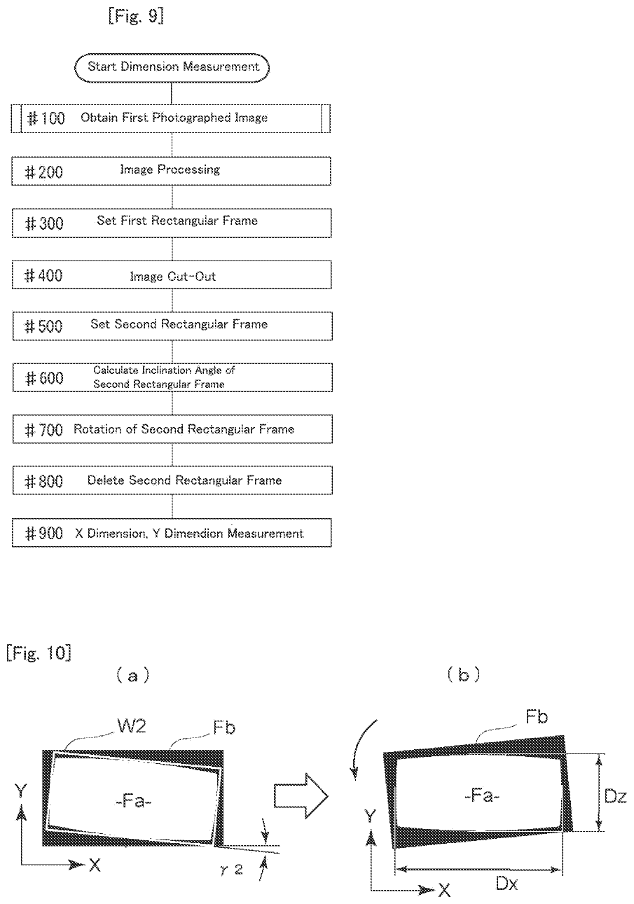

With respect to a method for the brightness adjustment will be described with reference to FIG. 5. Now, contents of FIG. 5 correspond to a subroutine of Step #100 in dimension measurement steps described based on FIG. 9.

The light source output power adjustment part U1 can be configured to start the dimension measurement of medicine 1 by the action, for example, that an operator fixes the medicine 1 to the medicine holder part H and presses a brightness adjustment switch 6 (#10). Besides, it is possible to start automatically by fixing the medicine 1 to the medicine holder part H and then closing a door of dimension measurement device S1.

When the brightness adjustment switch 6 is pressed, the voltage that is applied by the light source output power adjustment part U1 is set to the magnitude corresponding to the environment temperature at that time (#20), the photographing part C takes the photograph of first photographed image F1 (#30), and the light source output power adjustment part U1 applies, relating to necessity depending on the first photographed image F1, new voltage for LED to the light source part L (#40).

### Brightness Adjustment Completion Display 1

After completion of the brightness adjustment for the light source part L and the brightness of the first photographed image F1 becomes the condition that satisfies requirements set beforehand (#50), the light source output power adjustment part U1 makes the display part 5 and so on disposed at an outer face of the medicine dispensing apparatus S2 display the acknowledgement of completion for the brightness adjustment. For this display, for example, one may be used that displays letters or drawing patterns for the completion on a monitor 5a, or one may be used that turns on a rump disposed separately from the monitor 5a.

### Brightness Adjustment Completion Display 2

Besides, while being different to the above described ones and if the brightness condition set beforehand is not completely satisfied, at the condition that brightness adjustment working scheduled by the light source output power adjustment part U1 beforehand is completed (#50), one may be accepted that displays the acknowledgement of completion of brightness adjustment on the display part 5.

For example, when a dimension measurement start button 7a is disposed as an operation part 7 to the monitor 5a as the display part 5 and after the time when the brightness adjustment working is completed by the light source output adjustment part U1, the operator operates the dimension measurement start button 7a and instructs to start the photographing of first photographed image F1 and to start the dimension measurement (#70).

Furthermore, the display for the completion of brightness adjustment (#60) may be displayed (#50), even if the brightness of the light source part L does not become optimized and after the time when a scheduled menu for the brightness adjustment is performed and completed. In this case, the contents of brightness adjustment working may be variously set such that number of times for brightness adjustment is set beforehand and the like. By setting number of times for brightness adjustment, the brightness of LEDs can be set to an approximately adequate. According to this configuration, after the operator charges the medicine 1 to the dimension measurement device S1, the brightness adjustment will completed in the light source output adjustment part U1 at the time that about certain time duration has passed so that the operator can perform other work while predicting the timing for promoting the sample photographing.

### Brightness Adjustment In Repeated Practicing

Now, as described above, even if the operator operates the dimension measurement start button 7a, in order to perform the brightness adjustment, during the time duration till the operator instructs to start photographing, the light source power adjustment part U1 may be configured such that the light source power adjustment part U1 repeats the brightness adjustment.

When the photographing part C includes the dimension measurement start button 7a as the operation part 7, the timing when the operator operates the dimension measurement start button 7a is optional. When it is assumed that the dimension measurement start button 7a is not operated after the brightness adjustment by the light source power adjustment part U1 has been completed, there is the possibility that the brightness of light source part L will change due to, for example, heating of light source part L. Thus, when the brightness adjustment is repeated until the medicine image Fa is actually photographed even though the brightness adjustment has been completed once, the photographed image F with the optimum brightness will be obtained.

### Sample Photographing Automatic Start

Now, without using the dimension measurement start button 7a, the configuration may be accepted, which the photographing part C automatically promotes to the sample photographing and dimension measurement at the time when the brightness adjustment is completed. For example, when the brightness of the photographed image F satisfies the condition set beforehand by the brightness adjustment with the light source output power adjustment part U1, the photographing part C can be configured to start automatically sample photographing. In this case, as described before, the acknowledgement of completion of brightness adjustment may be displayed on the display part 5 (#60).

According to this configuration, the operation of dimension measurement start button 7a by the operator can be omitted. In this case, since sample photographing is performed immediately upon the brightness of photographed image F satisfying the predetermined condition, the photographed image F for dimension measurement can be obtained in the shortest time duration after charging the medicine 1.

Now, such embodiment of automatic start by the photographing part C may be one that is performed after the completion of brightness adjustment working of the light source part L with the scheduled contents by the light source output power adjustment part U1. That is to say, after the completion of brightness adjustment working with the predetermined contents, the acknowledgement for completion of brightness adjustment is displayed (#60), subsequently, sample photographing is started automatically. By configuring as described above, the time duration from the start of brightness adjustment by the light source output power adjustment part U1 to the completion of dimension measurement of medicine 1 by the photographing part C can be constant so that the brightness may be set adequately within determined time duration.

In addition, as described above, when a plurality of times of test photographing for the brightness adjustment is performed, the most recent brightness is principally set as the brightness of light source part L. However, since it is thought that the brightness obtained in the recent test photographing turns to inadequate, the configuration may be preferred that the optimized one among the brightness obtained past is selected.

### Dimension Measurement In First Posture

When the brightness adjustment is completed, sample photographing is performed subsequently. Although the brightness adjustment and the sample photographing are principally performed every time when the posture of the medicine holder part H changes; normally, it is started from the condition where the medicine holder part H is in the first posture. Based on the photographed image F1 obtained by this sample photographing, a shape measurement part U2 measures an X dimension and a Y dimension in an X direction and a Y direction which are orthogonal each other. These are, in short, a width dimension Dx and a vertical dimension Dy of medicine 1.

Now, in the present embodiment, a description of directions and a description of dimensions of medicine 1 is defined as follows:

With respect to the description of direction, the lateral direction in the first photographed image F1 and the second photographed image F2 is defined as an X direction and the vertical direction is defined as a Y direction.

With respect to the description of dimension of medicine 1, in the first photographed image F1, the X dimension measured along the X direction is the width dimension Dx and the Y dimension measured along the Y direction is the vertical direction Dy. In the second photographed image F2, the width dimension Dx is similarly handled and the X dimension measured along the X direction becomes the width dimension Dx, however, the Y dimension measured along the Y direction becomes a height dimension Dz, i.e., the dimension indicating the thickness of medicine 1.

### Gray Scale Conversion and Binarization

FIG. 9 shows procedures for dimension measurements. In step #100, the first photographed image F1 is taken, and then, various image processings are applied so as to obtain an image suitable to the dimension measurement (#200). For photographing, the red LED is used because the precise outline of medicine 1 is easy to be obtained. Therefore, in order to make the later dimension measurement easy, as shown in FIG. 6 (a), the first photographed image F1 is converted to a grayscale, and then is subjected to binarization. Furthermore, as shown in FIG. 6 (b), the image in FIG. 6 (a) is reverted, reduced and expanded to remove noises.

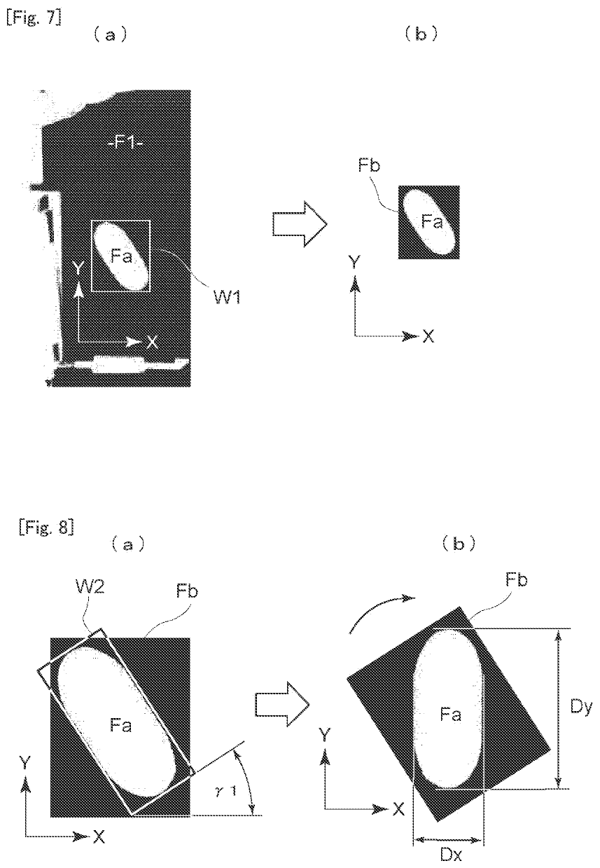

Subsequently, as shown in FIG. 7 (a), the medicine image Fa in the first photographed image F1 is enclosed with a first rectangular frame W1 (#300). Subsequently, as shown in FIG. 7 (b), only the part of medicine 1 is cut to obtain a cut-out image Fb (#400).

### Skew Correction

If the shape of medicine 1 is planer one and the plane shape is not a perfect circle, there is the possibility that the medicine 1 is inclinedly fixed when the medicine 1 is held to the pair of arm parts H3, H4 of medicine holder part H. For example, that is the case that the longitudinal direction of medicine 1 is slightly inclined rather than being set vertically to the rotation shaft X of medicine holder part H. In such case, the measured width dimension Dx becomes longer. In order to prevent such inconvenience, a skew correction is performed to the medicine image Fa.

The procedures for the skew correction is shown in FIG. 8. When the skew correction is performed, in order to extract only the region of medicine 1, after obtaining the first photographed image F1 (#100), the minimum first rectangular frame W1 which encloses the medicine 1 is set (FIG. 7 (a), #300), and the region of medicine image Fa is cut-out to obtain the cut-out image Fb (FIG. 7 (b), #400). Each side of first rectangular frame W1 is parallel to the X direction or the Y direction of first photographed image F1.

Next, the cut-out image Fb is enclosed by a second rectangular frame W2 which has sides along the long side direction and the narrow side direction perpendicular to the long side of medicine 1 (FIG. 8 (a), #500) to perform the skew correction. For setting the second rectangular frame W2, for example, a pair of parallel lines is rotated above the cut-out image Fb and is displaced to the position sandwiching the medicine 1 for each of various angles. Thereby, the outline of medicine image Fa is enclosed in the state with contacting four sides having the maximum of the difference between the long side and the narrow side so that the second rectangular frame W2 may be set. The elongation direction of the parallel lines when a spacing between a pair of the parallel lines becomes the narrowest corresponds to the long side direction of medicine 1. Next, another pair of parallel lines perpendicular to a pair of the parallel lines is set to sandwich the outline of medicine 1.

When the second rectangular frame W2 is defined, an angular difference between the long side direction of the second rectangular frame W2 and the Y direction of the first photographed image F1, i. e., the cut-out image Fb is calculated (#600). Subsequently, the cut-out image is rotated for this angle (FIG. 8 (b), #700) to complete the skew correction.

After completion of skew correction of medicine image Fa, under the condition where the second rectangular frame W2 is deleted (FIG. 8 (b), #800), the width dimension Dx and the vertical dimension Dy perpendicular thereto of medicine 1 are measured (FIG. 8 (b), #900). The width dimension Dx is the dimension of medicine 1 measured along the X direction of first photographed image F1. Now, the X direction of first photographed image F1 is the same direction with the direction along the rotation shaft X of medicine holder part H.

As described above, if the width dimension Dx is measured under the condition where the second rectangular frame W2 is deleted, for example, there is no need to change a dimension measurement program with a measurement angle depending on the inclination of medicine 1 and so on. Besides, when the dimension of medicine 1 is intended to obtain by calculation from the medicine image Fa, since the outer shapes of medicine 1 has various convex shapes, errors occur in extraction of the long diameter position and the short diameter position such that the errors in the dimension calculation may be accumulated. However, as the configuration of the present invention, one that a normal X dimension is measured after the skew correction does not produce such errors such that the precise dimension of medicine 1 can be measured.

The width dimension Dx of medicine image Fa obtained from the first posture becomes a candidate value for an official width dimension Dx. Thereby, usually, the width dimension Dx becomes the value less than the vertical dimension of medicine 1. The width dimension Dx becomes a standard for setting the width of passage of medicine 1 in the cassette 2 of medicine dispensing apparatus S2.

### Dimension Measurement in Second Posture

The purpose for photographing the medicine 1 in the second posture is mainly to measure the height dimension Dz of medicine 1. By measuring the height dimension, the height of passage for the medicine 1 can be set in the cassette 2 of medicine dispensing apparatus.

However, when the medicine 1 is fixed to the medicine holder part H, the medicine 1 can not be always stably put on the placement face H2. Since the placement of medicine 1 to the medicine holder part H, for example, there may be the case where the part of medicine 1 becomes raised to the light axis direction of photographing part C. In such case, the longitudinal direction of medicine 1 becomes anti-parallel to the X direction of second photographed image F2 in the second photographed image F2. Therefore, if the height dimension Dz of medicine image Fa is measured just as it is, the precise thickness can not be measured. In addition, as the result of inclination of long side direction of medicine 1, the error is also produced in the width direction Dx of medicine 1.

Thus, in order to correct these measurement errors, the similar skew correction with one that applied to the first photographed image F1 is also applied to the second photographed image F2. The inclination of medicine image Fa in the second photographed image F2 is caused by the inclined placement of medicine 1 on the placement face H2. Therefore, as shown in FIG. 10, when the skew correction is applied to the second photographed image F2, it is preferred that the long side of second rectangular frame W2 is made to be disposed along the X direction of cut-out image Fb. Thereby, more precise measurements of height dimension Dz and width dimension Dx of medicine 1 can be achieved.

### Dimension Evaluation Based On Skew Correction

Now, when the skew correction is applied, the following dimension evaluation may be preferred depending on the case where the object image for correction is either the first photographed image F1 or the second photographed image F2, or large or small of rotation angles γ1, γ2 relating to the skew correction (FIG. 8, FIG. 10).

### DIMENSION EVALUATION 1

When the rotation angle γ1 is larger than the predetermined threshold value in the skew correction to the first photographed image F1, it is preferred that the width dimension Dx after the skew correction about the first photographed image F1 is determined to the official width dimension Dx of medicine 1.

The reason why the medicine image Fa becomes largely inclined in the first photographed image F1 is cause by the fact that the posture does not always constant upon placing the medicine 1 on the placement face H2 due to less difference between the width dimension Dx and the vertical dimension Dy of medicine 1. Therefore, when the rotation angle γ1 of skew correction about the first photographed image F1 is larger than the predetermined threshold, the width dimension Dx after the skew correction becomes the nearer value to the precise width dimension Dx of medicine 1. This threshold value is, for example, to be 15 degrees.

### DIMENSION EVALUATION 2

When the rotation angle γ1 is smaller than the predetermined threshold value in the skew correction to the first photographed image F1, it is preferred that the width dimension Dx after the skew correction about the second photographed image F2 is determined to the official width dimension Dx of medicine 1.

When the shape of medicine 1 has a stick shape and so on in which the vertical dimension Dy is longer than the width dimension Dx of medicine 1, most cases has less inclination or no inclination in the medicine image Fa in the first photographed image F1. However, even though the shape of medicine 1 has a long and thin shape, there may be the case where the part of medicine 1 is raised against the placement face H2. That is to say, when the shape of medicine 1 is the stick shape, there are less needs for the skew correction in the first photographed image F1 but the skew correction may be required in the second photographed image F2. Therefore, for example, the threshold value of rotation angle γ2 in the skew correction to the second photographed image F2 is set to be 15 degrees, and if the rotation angle γ2 in the skew correction is less than this value, particularly the skew correction to the photographed image F2 is focused.

When the skew correction subsequently performed is necessary in the second photographed image F2, since such case is the case where the placement condition is inadequate where the part of medicine 1 is raised up and so on, in this case, it is preferred that the final width dimension Dx of medicine 1 is set to the width dimension Dx after the skew correction.

### Dimension Evaluation 3

With comparing the width dimension Dx after the skew correction about the first photographed image F1 to the width dimension Dx after the skew correction about the second photographed image F2, the width dimension Dx of longer one may be the final width dimension Dx of medicine 1.

As the cases to which the skew correction must be considered in both of the first photographed image F1 and the second photographed image F2, this case is thought that there are less differences in the width direction and the height direction of medicine 1 and also a surface shape of the part of medicine 1 contacting to the placement face H2 has a convex shape. Such medicine 1 does not become stable in its placement posture and the posture when passing through the dispensing passage becomes variable.

Therefore, with respect to such medicine 1, for making sure of dispensation, it is preferred to set the width dimension of medicine 1 to be the maximum value. Thereby, by adopting the larger dimension between the width dimension Dx obtained from the first photographed image F1 and the width dimension Dx obtained from the second photographed image F2, smooth dispensation working for the medicine 1 cane be realized.

Now, the medicine is photographed in a plurality of states with different light source brightness each other, and based on a plurality of the photographed images, the medicine shape may be measured. For example, the average between thee X dimension measured based on the image photographed at the condition where the brightness of light source is high and the X dimension measured based on the image photographed at the condition where the brightness of light source may be adopted as the X dimension of medicine.

### INDUSTRIAL APPLICABILITY

The dimension measurement device of present invention may be widely applied to ones that the dimension of medicine is measured by the image which photographs the medicine.

### DESCRIPTION OF SIGNS

1 medicine

operation part

C photographing part

F photographed image

F1 first photographed image

F2 second photographed image

Fa medicine image

H medicine holder part

H2 placement face

H3, H4 a pair of arm parts

L light source part

S1 dimension measurement device

U1 light source output power adjustment part

U2 shape measurement part

X rotation axis shaft

1. A dimension measurement device comprising:
a light source part;
a photographing part;
a medicine holder part holding a medicine disposed between the photographing part and the light source part while holding the medicine being able to be photographed from different directions;
a light source output power adjustment part performing brightness adjustment of the light source part based on brightness of a photographed image photographed with the photographing part; and
a dimension determination part measuring an X dimension and a Y dimension of the medicine in the X direction and the Y direction crossing at right angles each other in the photographed image photographed after performing at least one brightness adjustment.

2. The dimension measurement device of claim 1, wherein the light source part illuminates the medicine from a position opposite to the photographing part and the medicine holder part is configured from a transparent material; and
the brightness adjustment of the light source part is performed based on luminosity of a region other than regions of the medicine, the light source part and the medicine holder part in the photographed image.

3. The dimension measurement device of claim 1, wherein the photographing part is disposed with an operation part for indicating start of photographing by an operator; and
as a result of the brightness adjustment of the light source part by the light source output power adjustment part, operation of the operation part is configured to be possible at a condition where luminosity of the photographed image satisfies a predetermined condition.

4. The dimension measurement device of claim 1, wherein the photographing part is disposed with an operation part for indicating start of photographing by an operator; and
operation of the operation part is configured to be possible at a condition where brightness adjustment working scheduled beforehand by the light source output power adjustment part is completed.

5. The dimension measurement device of claim 3, wherein the brightness adjustment of the light source part by the light source output power adjustment part is configured to be performed repeatedly until the operator instructs start of photographing.

6. The dimension measurement device of claim 1, wherein the photographing part is configured to take photograph automatically if luminosity of the photographed image satisfies a condition set beforehand as a result of brightness adjustment of the light source by the light source output power adjustment part.

7. The dimension measurement device of claim 1, wherein the photographing part is configured to perform photographing automatically after completion of the brightness adjustment of the light source scheduled beforehand by the light source output power adjustment part.

8. The dimension measurement device of claim 1, wherein the medicine holder part comprises a placement part for placing the medicine and a pair of arm parts sandwiching the medicine by changing spacing each other along the placement face upon holding the medicine.

9. The dimension measurement device of claim 8, wherein the medicine holder part comprises a rotation axis shaft along a direction for changing the spacing between a pair of the arm parts and is able to change the placement face between a first posture and a second posture being right angled each other about the rotation axis shaft; wherein
if the first posture is set to a posture where a light axis of the photographing part and the placement face cross at right angles;
the photographing part photographs;
a first photographed image if the medicine holder part is at the first posture; and
a second photographed image if the medicine holder part is at the second posture; and
wherein
the dimension determination part sets to at least one of the first photographed image and the second photographed image a rectangular frame that encloses an outline of a medicine image showing the medicine as a condition with contacting four sides while making a difference between a long side and a narrow side maximum, calculates a minimum rotation angle for making the rectangular frame rotate so as to align with a direction along the rotation axis shaft or a direction perpendicular to the rotation axis shaft, performs skew correction by making rotate the medicine image for the rotation angle, and calculates the X dimension using a direction along the rotation axis shaft as the X direction for the medicine image performed with the skew correction.

10. The dimension measurement device of claim 9, wherein if the rotation angle in the first photographed image is not less than a threshold value set beforehand;
the X dimension after the skew correction to the first image is set as the final X dimension of the medicine.

11. The dimension measurement device of claim 9, wherein if the rotation angle in the first photographed image is less than a threshold value set beforehand;
the X dimension after the skew correction to the second image is set as the final X dimension of the medicine.

12. The dimension measurement device of claim 9, wherein the X dimension after the skew correction for the first photographed image and the X dimension after the skew correction for the second photographed image are compared and the X dimension of larger one is set as the final X dimension of the medicine.

13. A method for dimension measurement using a dimension measurement device comprising:
a light source part;
a photographing part;
a medicine holder part holding a medicine disposed between the photographing part and the light source part while holding the medicine being able to be photographed from different directions;
a dimension determination part measuring an X dimension and a Y dimension of the medicine in the X direction and the Y direction crossing at right angles each other in the photographed image photographed after performing at least one brightness adjustment, and when performing dimension measurement of the medicine, the method performing;
setting a posture of the medicine to an light axis of the photographing part to at least either a first posture or a second posture crossing at right angles each other, after setting the light source part to predetermined brightness, obtaining the photographed image with the photographing part, after preparatory photographing at least one time for measuring luminosity of the photographed image, and performing sample photographing.

14. The method of claim 13, wherein the medicine holder part comprises;
a placement part for placing the medicine;
a pair of arm parts sandwiching the medicine by changing spacing each other along the placement face upon holding the medicine; and
a rotation axis shaft along a direction for changing the spacing between a pair of the arm parts and crossing the light axis at right angles;
wherein
if the first posture is assumed to be a posture where the placement face crosses the light axis at right angles;
making the placement face rotate about the rotation axis shaft to achieve the first posture or the second posture;
after the sample photographing, enclosing an outline of the medicine image showing the medicine in the photographed image with a rectangular frame as a condition with contacting four sides while making a difference between a long side and a narrow side maximum,
calculating a minimum rotation angle for making the rectangular frame rotate so as to align with a direction along the rotation axis shaft or a direction perpendicular to the rotation axis shaft to perform skew correction by making rotate the medicine image for the rotation angle, and
calculating the X dimension using a direction along the rotation axis shaft as the X direction for the medicine image performed with the skew correction.

1. A dimension measurement device comprising:
a light source part;
a photographing part;
a medicine holder part holding a medicine disposed between the photographing part and the light source part while holding the medicine being able to be photographed from different directions;
a light source output power adjustment part performing brightness adjustment of the light source part based on brightness of a photographed image photographed with the photographing part; and
a dimension determination part measuring an X dimension and a Y dimension of the medicine in the X direction and the Y direction crossing at right angles each other in the photographed image photographed after performing at least one brightness adjustment.

2. The dimension measurement device of claim 1, wherein the light source part illuminates the medicine from a position opposite to the photographing part and the medicine holder part is configured from a transparent material; and
the brightness adjustment of the light source part is performed based on luminosity of a region other than regions of the medicine, the light source part and the medicine holder part in the photographed image.

3. The dimension measurement device of claim 1 or 2, wherein the photographing part is disposed with an operation part for indicating start of photographing by an operator; and
as a result of the brightness adjustment of the light source part by the light source output power adjustment part, operation of the operation part is configured to be possible at a condition where luminosity of the photographed image satisfies a predetermined condition.

4. The dimension measurement device of claim 1 or 2, wherein the photographing part is disposed with an operation part for indicating start of photographing by an operator; and
operation of the operation part is configured to be possible at a condition where brightness adjustment working scheduled beforehand by the light source output power adjustment part is completed.

5. The dimension measurement device of claim 3 or 4, wherein the brightness adjustment of the light source part by the light source output power adjustment part is configured to be performed repeatedly until the operator instructs start of photographing.

6. The dimension measurement device of claim 1 or 2, wherein the photographing part is configured to take photograph automatically if luminosity of the photographed image satisfies a condition set beforehand as a result of brightness adjustment of the light source by the light source output power adjustment part.

7. The dimension measurement device of any one of claim 1, 2, or 6, wherein the photographing part is configured to perform photographing automatically after completion of the brightness adjustment of the light source scheduled beforehand by the light source output power adjustment part.

8. The dimension measurement device of any one of claims 1-7, wherein the medicine holder part comprises a placement part for placing the medicine and a pair of arm parts sandwiching the medicine by changing spacing each other along the placement face upon holding the medicine.

9. The dimension measurement device of claim 8, wherein the medicine holder part comprises a rotation axis shaft along a direction for changing the spacing between a pair of the arm parts and is able to change the placement face between a first posture and a second posture being right angled each other about the rotation axis shaft;
wherein
if the first posture is set to a posture where a light axis of the photographing part and the placement face cross at right angles;
the photographing part photographs;
a first photographed image if the medicine holder part is at the first posture; and
a second photographed image if the medicine holder part is at the second posture; and
wherein
the dimension determination part sets to at least one of the first photographed image and the second photographed image a rectangular frame that encloses an outline of a medicine image showing the medicine as a condition with contacting four sides while making a difference between a long side and a narrow side maximum, calculates a minimum rotation angle for making the rectangular frame rotate so as to align with a direction along the rotation axis shaft or a direction perpendicular to the rotation axis shaft, performs skew correction by making rotate the medicine image for the rotation angle, and calculates the X dimension using a direction along the rotation axis shaft as the X direction for the medicine image performed with the skew correction.

10. The dimension measurement device of claim 9, wherein if the rotation angle in the first photographed image is not less than a threshold value set beforehand;
the X dimension after the skew correction to the first image is set as the final X dimension of the medicine.

11. The dimension measurement device of claim 9, wherein if the rotation angle in the first photographed image is less than a threshold value set beforehand;
the X dimension after the skew correction to the second image is set as the final X dimension of the medicine.

12. The dimension measurement device of claim 9, wherein the X dimension after the skew correction for the first photographed image and the X dimension after the skew correction for the second photographed image are compared and the X dimension of larger one is set as the final X dimension of the medicine.

13. A method for dimension measurement using a dimension measurement device comprising:
a light source part;
a photographing part;
a medicine holder part holding a medicine disposed between the photographing part and the light source part while holding the medicine being able to be photographed from different directions;
a dimension determination part measuring an X dimension and a Y dimension of the medicine in the X direction and the Y direction crossing at right angles each other in the photographed image photographed after performing at least one brightness adjustment, and when performing dimension measurement of the medicine, the method performing;
setting a posture of the medicine to an light axis of the photographing part to at least either a first posture or a second posture crossing at right angles each other, after setting the light source part to predetermined brightness, obtaining the photographed image with the photographing part, after preparatroty photographing at least one time for measuring luminosity of the photographed image, and performing sample photographing.

14. The method of claim 13, wherein the medicine holder part comprises;
a placement part for placing the medicine;
a pair of arm parts sandwiching the medicine by changing spacing each other along the placement face upon holding the medicine; and
a rotation axis shaft along a direction for changing the spacing between a pair of the arm parts and crossing the light axis at right angles;
wherein
if the first posture is assumed to be a posture where the placement face crosses the light axis at right angles;
making the placement face rotate about the rotation axis shaft to achieve the first posture or the second posture;
after the sample photographing, enclosing an outline of the medicine image showing the medicine in the photographed image with a rectangular frame as a condition with contacting four sides while making a difference between a long side and a narrow side maximum,
calculating a minimum rotation angle for making the rectangular frame rotate so as to align with a direction along the rotation axis shaft or a direction perpendicular to the rotation axis shaft to perform skew correction by making rotate the medicine image for the rotation angle, and
calculating the X dimension using a direction along the rotation axis shaft as the X direction for the medicine image performed with the skew correction.
